(19) United States
(12) Patent Application Publication
(10) Pub. No.: US 2021/0333568 A1
(43) Pub. Date: Oct. 28, 2021

(54) DRIVE CONTROL APPARATUS, DRIVE CONTROL METHOD AND COMPUTER READABLE MEDIUM HAVING DRIVE CONTROL PROGRAM RECORDED THEREON

(71) Applicant: Asahi Kasei Microdevices Corporation, Tokyo (JP)

(72) Inventors: Keita OKADA, Tokyo (JP); Hiroaki AIBA, Tokyo (JP)

(21) Appl. No.: 17/194,321

(22) Filed: Mar. 8, 2021

(30) Foreign Application Priority Data
Apr. 24, 2020 (JP) 2020-077448
Dec. 8, 2020 (JP) 2020-203678

(51) Int. Cl. G02B 27/64; H04N 5/232; G03B 5/00

(52) U.S. Cl. CPC G02B 27/646; G03B 5/00; H04N 5/23287; H04N 5/23212

(57) ABSTRACT

Provided is a drive control apparatus, comprising: a drive control unit for generating driving force for driving a drive target object by a drive apparatus in a first operating state, and performing control to reduce or stop the driving force of the drive apparatus in a second operating state; a detection unit for detecting a position change of the drive target object; and a state control unit for transitioning the drive control unit to the first operating state to make the drive control unit perform control to generate the driving force by the drive apparatus to suppress a continued position change in response to a position change exceeding predetermined criteria being detected in the second operating state.

The contents of the following Japanese patent application is incorporated herein by reference:
NO. 2020-077448 filed in JP on Apr. 24, 2020
NO. 2020-203678 filed in JP on Dec. 8, 2020

### BACKGROUND

### 1. Technical Field

The present invention relates to a drive control apparatus, a drive control method and a computer readable medium having a drive control program recorded thereon.

### 2. Related Art

Patent Document 1 relates to a method for controlling a lens position in an image capturing apparatus. Patent Document 1 states that “when the mode microcomputer 32 detects that the power switch 33 is switched off, . . . after a predetermined period of time, the lens holding frame 13 is instantly moved from the optical axis 4 to the position corresponding to the set value R, and then the moved lens holding frame 13 is gradually moved to the vicinity of the inner wall of the lens barrel 2 so that the lens holding frame 13 contacts the inner wall of the lens barrel 2, thereby the shift lens 7 can be prevented from falling under its own weight and generating an annoying collision noise between the lens holding frame 13 holding the shift lens 7 and the inner wall of the lens barrel 2 even when the shift lens 7, which has been floating due to anti-vibration control, is turned off” (paragraph 0056).

### PRIOR ART DOCUMENT

### Patent Document

Patent Document 1: Japanese Patent Application Publication No. 2000-066259

### SUMMARY

A first aspect of the present invention provides a drive control apparatus. The drive control apparatus may include a drive control unit for generating driving force for driving a drive target object by a drive apparatus in a first operating state, and performing control to reduce or stop the driving force of the drive apparatus in a second operating state. The drive control apparatus may include a detection unit for detecting a position change of the drive target object. The drive control apparatus may include a state control unit for transitioning the drive control unit to the first operating state to make the drive control unit perform control to generate the driving force by the drive apparatus to suppress a continued position change in response to a position change exceeding predetermined criteria being detected in the second operating state.

The drive apparatus may be configured to apply magnetic force to a magnet provided in the drive target object and driving the drive target object in the first operating state by driving a coil. The drive apparatus may reduce the magnetic force or to stop generating the magnetic force in the second operating state, and to be set to a state in which the drive target object is movable when external force is applied thereto.

The state control unit may be configured to transition the drive control unit to the second operating state in response to elapse of a predetermined period after switching the drive control unit to the first operating state by detecting a position change exceeding the predetermined criteria.

The detection unit may include a vibration detection unit for detecting a vibration of the drive target object. The state control unit may transition the drive control unit from the second operating state to the first operating state in response to the vibration being detected by the vibration detection unit.

The drive control unit may be configured to perform control for generating the driving force to suppress the vibration by the drive apparatus in response to a transition to the first operating state by detecting a position change exceeding the predetermined criteria.

The drive target object may be housed in a housing. The drive control unit may be configured to perform control to move the drive target object to a predetermined fixed position within the housing in response to a transition to the first operating state by detecting a position change exceeding the predetermined criteria.

The drive control apparatus may further include a target position setting unit for setting a target position of the drive target object. The target position setting unit may be configured to output position information indicating the fixed position in response to the drive control unit transitioning to the first operating state by detecting a position change exceeding the predetermined criteria. The drive control unit may be configured to perform control to move the drive target object to the fixed position based on the position information.

The fixed position may be an end point of a range of movement of the drive target object.

The drive control unit may be configured to perform control to generate, by the drive apparatus, the driving force that does not cause the drive target object to contact a structure at an end point of the range of movement of the drive target object in response to a transition to the first operating state by detecting a position change exceeding the predetermined criteria.

The detection unit may be configured to detect a position change of the drive target object that exceeds the predetermined criteria based on a displacement amount of a detected position.

The detection unit may be configured to detect a position change exceeding the predetermined criteria of the drive target object when a displacement amount of the detected position is greater than a threshold value.

The detection unit may be configured to detect a position change exceeding the predetermined criteria of the drive target object when at least one of speed or acceleration based on a displacement amount of the detected position and a period of time for the drive target object being displaced in the displacement amount is greater than a threshold value.

The detection unit may be configured to detect a position change exceeding the predetermined criteria of the drive target object based on the number of times of the drive target object crossing a predetermined reference position.

The detection unit may be configured to detect a position change exceeding the predetermined criteria based on a number of times of the drive target object crossing a plurality of the predetermined reference position.

The drive target object may be a lens of an image capturing apparatus. The drive control unit may perform control of at least one of focusing, zooming or blur suppressing the lens by driving the lens when performing image capturing by the image capturing apparatus.

A second aspect of the present invention provides a drive system. The drive system may include the drive control apparatus. The drive system may include a drive apparatus for driving the drive target object according to the control by the drive control apparatus.

A third aspect of the present invention provides a drive control method. The drive control method may include causing a drive control apparatus to generate driving force for driving a drive target object by a drive apparatus in a first operating state, and to reduce or stop the driving force of the drive apparatus in a second operating state. The drive control method may include detecting, by the drive control apparatus, a position change of the drive target object. The drive control method may include transitioning, by the drive control apparatus, to the first operating state in response to a position change exceeding predetermined criteria being detected in the second operating state and to perform control to generate the driving force by the drive apparatus.

A fourth aspect of the present invention provides a computer-readable medium having recorded thereon a drive control program executed by a computer. The drive control program may cause the computer to function as a drive control unit for generating driving force, for driving a drive target object by a drive apparatus in a first operating state and performing control to reduce or stop the driving force of the drive apparatus in a second operating state. The drive control program may cause the computer to function as a detection unit for detecting a position change of the drive target object. The drive control program may cause the computer to function as a state control unit for transitioning the drive control unit to the first operating state to make the drive control unit perform control to generate the driving force by the drive apparatus in response to a position change exceeding predetermined criteria being detected in the second operating state.

The summary clause does not necessarily describe all necessary features of the embodiments of the present invention. The present invention may also be a sub-combination of the features described above.

### BRIEF DESCRIPTION OF THE DRAWINGS

FIG. 1 illustrates a configuration of a drive system 10 according to an embodiment of the present invention.

FIG. 2 illustrates an operation flow of the drive system 10 in an operating state according to an embodiment of the present invention.

FIG. 3 illustrates an operation flow of the drive system 10 starting from a stop state according to an embodiment of the present invention.

FIG. 4 illustrates a first example of a vibration detection method of the drive system 10 according to the present embodiment.

FIG. 5 illustrates a second example of the vibration detection method of the drive system 10 according to the present embodiment.

FIG. 6 illustrates a third example of the vibration detection method of the drive system 10 according to the present embodiment.

FIG. 7 illustrates an example of a computer 2200 through which a plurality of aspects of the present invention may be entirely or partially embodied.

### DESCRIPTION OF EXEMPLARY EMBODIMENTS

Hereinafter, the invention will be described through embodiments of the invention, but the following embodiments do not limit the invention according to claims. Also, all combinations of features described in the embodiments are not necessarily essential to solutions of the invention.

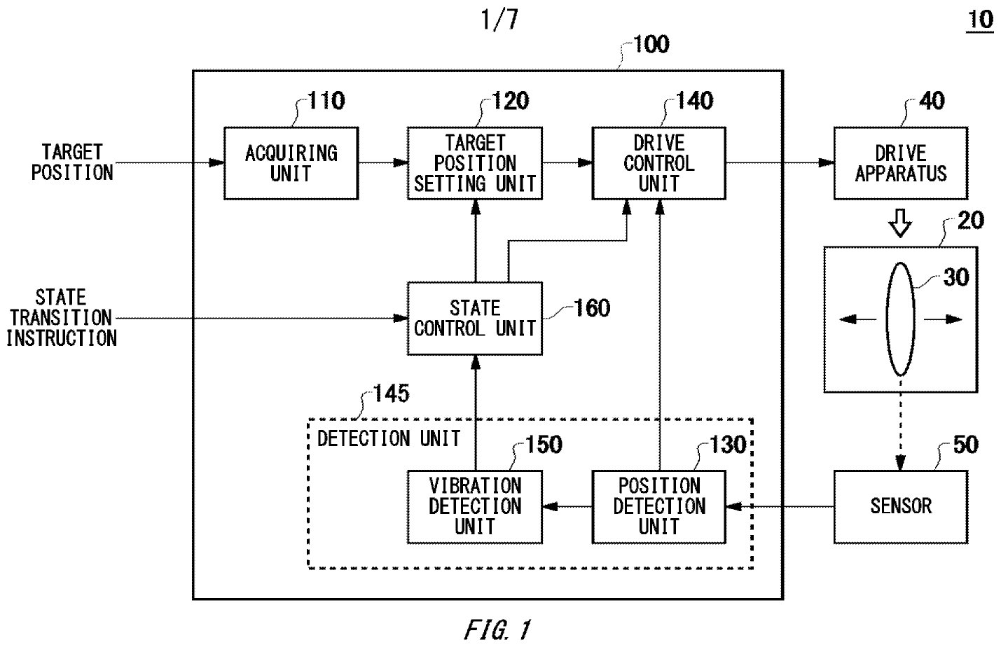

FIG. 1 illustrates a configuration of a drive system 10 according to the present embodiment together with a housing 20 and a drive target object 30. The drive system 10 is configured to generate a driving force for driving the drive target object 30 by a drive apparatus 40 to drive the drive target object 30 in a first operating state of the drive apparatus 40. Also, the drive system 10 is configured to reduce or stop the driving force of the drive apparatus 40 to stop the drive of the drive target object 30 in a second operating state of the drive apparatus 40. The drive system 10 according to the present embodiment is configured to transition from the second operating state to the first operating state and drive the drive target object 30 to suppress the continuation of a position change due to a vibration or the like, in response to the occurrence of the position change exceeding the predetermined criteria due to the occurrence of a vibration or the like in the drive target object 30 in the second operating state.

The housing 20 is configured to house the drive target object 30 therein. The housing 20 may be integrated with a housing for accommodating the drive apparatus 40, a sensor 50 and a drive control apparatus 100, or may be a separate housing attachable to and detachable from the housing for accommodating the drive apparatus 40, the sensor 50 and the drive control apparatus 100.

The drive target object 30 is housed by the housing 20, and driven by the drive system 10. The drive target object 30 may be, for example, a lens, a mirror, an image sensor or another optical component provided in an image capturing apparatus such as a camera or a video camera. Also, the drive target object 30 may also be another component having its position or posture driven by a drive system 10, and the drive system 10 may be configured to suppress a vibration or the like generated in the drive target object 30 when not driving the drive target object 30. In the present embodiment, the drive target object 30 is a lens of an image capturing apparatus as one example.

The drive apparatus 40 is configured to be connected to the drive control apparatus 100 and to drive the drive target object 30 inside the housing 20 according to the control by the drive control apparatus 100. The drive apparatus 40 is configured to move the drive target object 30 using the driving force such as magnetic force, electrostatic force, or mechanical force. For example, the drive apparatus 40 may apply the magnetic force on a magnet provided in the drive target object 30 by driving a coil and move the drive target object 30. Further for example, the drive apparatus 40 may also mechanically move drive target object 30 using a cantilever type piezoelectric element. According to the present embodiment, when performing image capturing by an image capturing apparatus with the drive target object 30 that is a lens, the drive apparatus 40 drives the lens (to move or to change its orientation or the like).

The sensor 50 is configured to be provided in the vicinity of the drive target object 30 and to output a measurement value according to the position of the drive target object 30. The sensor 50 is, for example, configured to output the measurement value according to the position of a magnet for position detection fixed on the drive target object 30 using a magnetic sensor such as a Hall element. Alternatively, the sensor 50 may also be a sensor of another type that is capable of measuring the position of the drive target object 30 electrically, magnetically or optically.

The drive control apparatus 100 is configured to be connected to the drive apparatus 40 and the sensor 50 and to control the drive of the drive target object 30 by the drive apparatus 40. The drive control apparatus 100 is, as one example, an integrated circuit (IC) including a dedicated circuit for controlling the drive of the drive target object 30. Also, the drive control apparatus 100 may also achieve at least a part of the functions of the drive control apparatus 100 by running the drive control program on a processor such as a micro controller provided inside the drive control apparatus 100. The drive control apparatus 100 includes an acquiring unit 110, a target position setting unit 120, a drive control unit 140, a detection unit 145 and a state control unit 160.

The acquiring unit 110 is configured to input the target position of the drive target object 30 from an external apparatus or a user. The target position setting unit 120 is connected to the acquiring unit 110 and the state control unit 160. The target position setting unit 120 is configured to set the target position of the drive target object 30. Herein, when the drive target object 30 is implemented for its original purpose in a case or the like where, for example, a lens is driven for image capturing in an image capturing apparatus, the target position setting unit 120 is configured to set the target position acquired by the acquiring unit 110 as the target position of the drive target object 30. When the drive control unit 140 and the drive apparatus 40 are transited to the first operating state for suppressing the vibration or the like of the drive target object 30, the target position setting unit 120 is configured to set the target position instructed from the state control unit 160 as the target position of the drive target object 30.

The drive control unit 140 is connected to the target position setting unit 120, the position detection unit 130 inside the detection unit 145 and the state control unit 160. The drive control unit 140 is configured to generate the driving force for driving the drive target object by the drive apparatus 40 in the first operating state, and to perform the control for reducing or stopping the driving force of the drive apparatus 40 in the second operating state. Herein, the drive control unit 140 may also be configured to control the drive of the drive target object 30 according to the first operating state, and to stop controlling the drive of the drive target object 30 according to the second operating state. In the present embodiment, the drive control unit 140 is set to the first operating state when performing image capturing by the image capturing apparatus, and is configured to drive and control the drive target object 30 to perform at least one of focusing, zooming, or blur suppression.

Herein, the first operating state is an operating state or an operating mode (for example, a state of normal operating mode) in which the drive apparatus 40 is operated to move the drive target object 30 to the target position or to bring it to rest at the target position, and is also referred to as an “operating state. The drive control unit 140 is configured to transition to the operating state in response to receiving the designation of being in the operating state from the state control unit 160. In the operating state, the drive control unit 140 is configured to perform the control on the supply of electrical power from the power supply to the drive apparatus 40 that enables normal operation, and may put the drive apparatus 40 into the operating state in the same manner as the drive control unit 140. Then, the drive control unit 140 is configured to supply drive signals to the drive apparatus 40 to switch the switching elements for driving and so on inside the drive apparatus 40 in order to move the drive target object 30 to the target position specified by the position information supplied by the target position setting unit 120 in the operating state. In this way, the drive apparatus 40 is configured to generate the driving force for driving the drive target object 30 and drive the drive target object 30. In the present embodiment, the drive apparatus 40 is configured to apply the magnetic force on the magnet provided in the drive target object 30 by driving the coil in the operating state and to drive the drive target object 30. It is noted that as described below, even in a case where the image capturing is not performed by the image capturing apparatus, the drive control unit 140 is configured to transition from the stop state (the second operating state) to the operating state for suppressing the vibration or the like of the drive target object 30.

The second operating state is an operating state in which the driving force of the drive target object 30 driven by the drive apparatus 40 is reduced compared to the first operating state, or stopped and may be a state in which the control of the drive of the drive target object 30 is stopped. The stop state may be an operating state or an operating mode in which the generation of the driving force for moving the drive target object 30 is stopped, or it may be an operating state or an operating mode in which the driving force is reduced to such an extent that the movement of the drive target object 30 cannot be stopped when some degree of acceleration is applied from outside (for example, a state in an operation stop mode or a power saving mode). The second operating state is also referred to as a “stop state”. The stop state may also be one for releasing the drive target object 30 to a state where it can be moved freely within the range of movement inside the housing 20. The drive control unit 140 is configured to transition to the stop state in response to receiving the designation of being in a stop state from the state control unit 160. In the stop state, the drive control unit 140 may stop controlling the drive of the drive target object 30 by the drive apparatus 40. As a result, the drive control unit 140 is configured to stop or weaken the generation of the driving force by the drive apparatus 40. In the stop state, the drive control unit 140 may be configured to switch the drive apparatus 40 to a power saving mode, or may stop supplying electrical power from the power supply to the drive apparatus 40. In this way, the drive control unit 140, in the stop state, may make the drive apparatus 40 also be in the stop state in the same manner as the drive control unit 140. Also, in the stop state, the drive control unit 140 may also be configured to switch at least a part of the drive control unit 140 (for example, a circuit part for supplying a drive signal to the drive apparatus 40) to the power saving mode, or to stop supplying electrical power from the power supply to this part.

In the present embodiment, the drive apparatus 40 is configured to reduce the magnetic force or to stop the generation of the magnetic force in the stop state, and to be set to a state in which the drive target object 30 can be moved within a range of movement when having been applied with external force. In other words, in the stop state, when having been applied with the same external force, the drive target object 30 is possible to be moved more when compared with the operating state.

The detection unit 145 is connected to the sensor 50. The detection unit 145 is configured to detect the position of the drive target object 30, and detect the position change of the drive target object 30 using the position. In the present embodiment, the detection unit 145 includes a position detection unit 130 and a vibration detection unit 150.

The position detection unit 130 is connected to the sensor 50. The position detection unit 130 is configured to detect the position of the drive target object 30 using the measurement value from the sensor 50.

The vibration detection unit 150 is connected to the position detection unit 130, and is configured to detect the vibration of the drive target object 30 using the position of the drive target object 30 detected by the position detection unit 130. Herein, “vibration” does not indicate the movement of the drive target object 30 due to the drive by the drive apparatus 40, but rather the position change of the drive target object 30 caused by being applied with external force as a device including the drive system 10 and the drive target object 30, such as an image capturing apparatus, is dropped, vibrated or shaken by the user's running or walking, or other. That is, the “vibration” that is a detection target of the vibration detection unit 150 does not necessarily involve a reciprocating movement, nor is it limited to a movement of the drive target object 30 that can become a reciprocating movement in the future. In the present embodiment, it is considered that the vibration detection unit 150 has detected a vibration when it has detected a position change of the drive target object 30 that exceeds predetermined criteria.

The state control unit 160 is connected to the vibration detection unit 150. The state control unit 160 is configured to transition the state of the drive control unit 140 between the operating state and the stop state in response to a state transition instruction from outside of the drive control apparatus 100. Also, the state control unit 160 is configured to transition the drive control unit 140 to be in the operating state from the stop state in response to the position change that exceeds the predetermined criteria having been detected by the detection unit 145 in the stop state, that is, the vibration of the drive target object 30 having been detected by the vibration detection unit 150 during the stop state in the present embodiment. In response to the transition to the operating state by the detection of this vibration, the drive control unit 140 is configured to perform the control to generate the driving force by the drive apparatus 40 and suppress the continued position change of the drive target object 30. This enables the drive control unit 140 to drive the drive apparatus 40 and to control the drive apparatus 40 by putting it in the operating state as needed in order to suppress the continued vibration of the drive target object 30 that has been detected by the vibration detection unit 150 in the stop state.

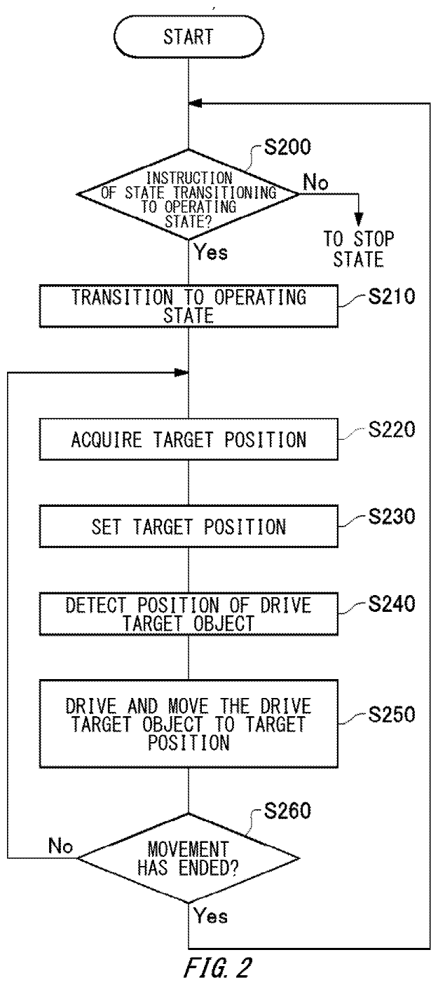

FIG. 2 illustrates an operation flow in the operating state of the drive system 10 according to the present embodiment. In step 200 (S200), the state control unit 160 is configured to determine whether an instruction of state transitioning to the operating state has been received from the outside of the drive control apparatus 100. In a case where there is no instruction of state transitioning to the operating state, or in a case where there is an instruction of state transitioning to the stop state (NO in S200), the state control unit 160 is configured to transition the drive control unit 140 and the drive apparatus 40 to the stop state. In a case where there has been an instruction of state transitioning to the operating state (YES in S200), in S210, the state control unit 160 is configured to transition the drive control unit 140 and the drive apparatus 40 to the operating state.

In S220, the acquiring unit 110 is configured to acquire the target position of the drive target object 30 from an external apparatus and so on. In S230, the target position setting unit 120 is configured to receive the designation of being in the operating state from the state control unit 160, then set the acquired target position as the target position of the drive target object 30, and output the position information indicating the target position to the drive control unit 140.

In S240, the position detection unit 130 is configured to detect the position (detected position) of the drive target object 30 using the measurement value from the sensor 50. In S250, the drive control unit 140 is configured to perform the control to drive the drive apparatus 40 so that the drive target object 30 is moved to the target position based on the target position and the detected position of the drive target object 30 indicated by the position information. The drive control unit 140 may perform the control to move the drive target object 30 so that the detected position of the drive target object 30 approaches to the target position of the drive target object 30. In response to this, the drive apparatus 40 is configured to generate the driving force for driving the drive target object 30 and move the drive target object 30 toward the target position.

In S260, the drive control unit 140 is configured to receive a new detected position of the drive target object 30 from the position detection unit 130, and then determine whether it has finished moving the drive target object 30 to the target position. If the movement of the drive target object 30 is not completed, the drive control unit 140 is configured to perform feedback control of the position of the drive target object 30 by advancing the process to S220. After the drive control apparatus 100 finishes moving the drive target object 30 to the target position, the device including the drive system 10 is configured to use the drive target object 30 to perform an actual usage of the drive target object 30 such as the image capturing of a subject. When the actual usage is over, the state control unit 160 is configured to advance the process to S200. Herein, after the actual usage of the drive target object 30 is completed, the state control unit 160 may transition the drive control unit 140 and the drive apparatus 40 to the stop state in response to an instruction from an apparatus outside the drive control apparatus 100 or the like, or in response to the detection of a timeout from an instruction of state transitioning to the final operating state, or the designation of the target position.

Instead of the above operation, the drive control unit 140 may perform open-loop control to move the drive target object 30 to the target position without using the detected position of the drive target object 30. In this case, the drive control apparatus 100 does not need to repeat the feedback loop from S220 to S260, nor does it need to use the detection result of the position of the drive target object 30 in S240.

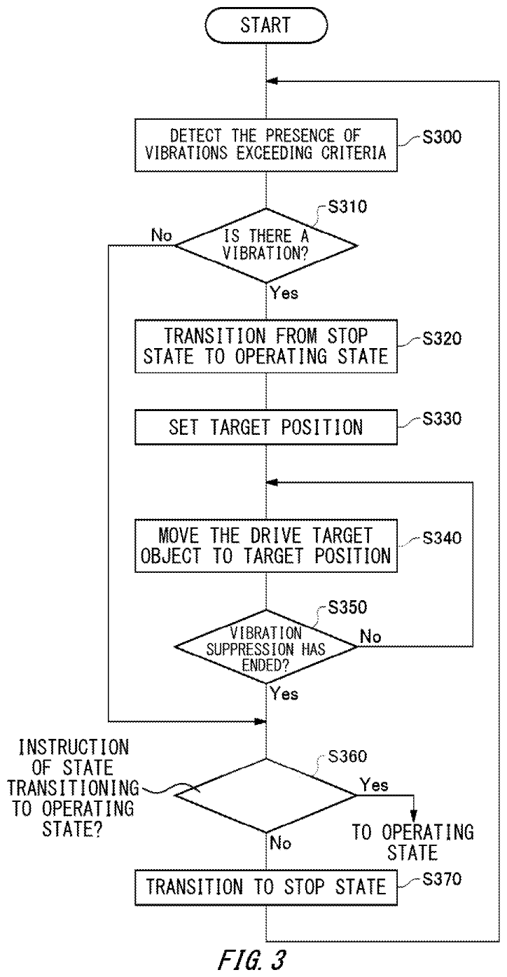

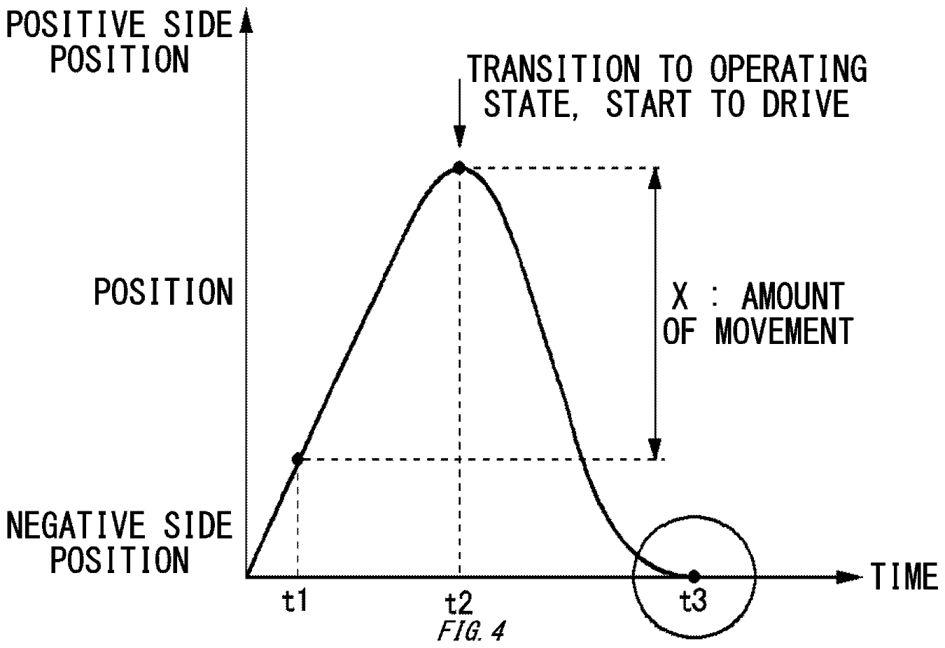

FIG. 3 illustrates an operation flow of starting from a stop state of the drive system 10 according to the present embodiment. In step S300, the vibration detection unit 150 is configured to detect whether there is a vibration in the drive target object 30 during the stop state. Herein, the vibration detection unit 150 is configured to detect the position change of the drive target object 30 exceeding the predetermined criteria as the “vibration”. Such criteria of the position change may be, as exemplified in FIG. 4 to FIG. 6, criteria regarding the magnitude of the displacement amount of the drive target object 30, criteria regarding the number of times of shaking, criteria regarding the magnitude of shaking, or any criteria for another feature or changing amount of the position change of the drive target object 30, or their combination. If the vibration is not detected by the vibration detection method used by the vibration detection unit 150 (NO in S310), in S310, the state control unit 160 is configured to advance the process to S360.

In a case where the vibration of the drive target object 30 has been detected (YES in S310), in S320, the state control unit 160 is configured to transition the drive control unit 140 and the drive apparatus 40 from the stop state to the operating state. In a case where at least a part of the drive control unit 140 or the drive apparatus 40 is set to the power saving mode in the stop state, the state control unit 160 is configured to transition them to the normal operating mode.

In S330, the state control unit 160 is configured to instruct the target position setting unit 120 to set the target position of the drive target object 30 to a predetermined fixed position inside the housing 20 in order to suppress the vibration of the drive target object 30. Herein, the state control unit 160 may have a storage apparatus such as a register or memory in which this fixed position has been set in advance, and may supply the fixed position set in such a storage apparatus to the target position setting unit 120. In this way, the target position setting unit 120 is configured to output position information indicating this fixed position to the drive control unit 140 in response to the transition to the operating state of the drive control unit 140 due to the detection of vibration of the drive target object 30.

In S340, the drive control unit 140 is configured to perform the control to move the drive target object 30 to the predetermined fixed position inside the housing 20 in response to the transition to the operating state by the detection of the vibration of the drive target object 30. In the present embodiment, the drive control unit 140 is configured to perform the control to move the drive target object 30 to the fixed position based on the position information output by the target position setting unit 120.

In S350, the state control unit 160 is configured to determine whether the suppression of the vibration of the drive target object 30 has ended. For example, the state control unit 160 is configured to determine that the suppression of the vibration has ended according to the elapse of a predetermined vibration suppression period (for example, 10 seconds, or other) after the drive control unit 140 is transitioned to the operating state by detecting the vibration of the drive target object 30. Herein, when using a timeout in S260, the state control unit 160 may also use a vibration suppression period of the same length as the timeout period. Alternatively, the state control unit 160 may be configured to instruct the drive control unit 140 not to apply the driving force to the drive target object 30 to suppress vibration, and to determine whether vibration suppression has ended by detecting whether the drive target object 30 is still vibrating. If the suppression of vibration has not ended, the state control unit 160 is configured to advance the process to S340 (NO in S350).

If no vibration of the drive target object 30 has been detected (NO in S310) or if the suppression of vibration has ended (YES in S350), in S360, the state control unit 160 is configured to determine whether an instruction of state transitioning to the operating state has been received. In a case where an instruction of state transitioning to the operating state has been received (YES in S360), the state control unit 160 is configured to transition the drive control unit 140 and the drive apparatus 40 to the operating state. In this case, the state control unit 160 may be configured to advance the process of the drive system 10 to the operation flow shown in FIG. 2.

In a case where an instruction of state transitioning to the operating state is not received (NO in S360), in S370, the state control unit 160 is configured to return to the state before detecting the vibration during the stop state (S300) by transitioning the drive control unit 140 and the drive apparatus 40 to the stop state.

According to the drive system 10 as shown above, if the vibration of the drive target object 30 is detected in the stop state of the drive control unit 140 and the drive apparatus 40, the drive target object 30 can be driven in order to make the drive control unit 140 and the drive apparatus 40 be in a temporary operating state to suppress the vibration of the drive target object 30. For example, when the drive system 10 is provided in the image capturing unit of a battery driven camera or a mobile terminal such as a smartphone, the drive system 10 has the drive control unit 140 and the drive apparatus 40 to be controlled to be in the stop state or the power saving mode except during actual use of the image capturing unit in order to suppress battery drain. In this case, the drive system 10 is configured to suppress or stop the supply of driving force to the drive target object 30, so that the drive target object 30 is released to move freely. In this state, when a large external motion is applied to a mobile terminal, the drive target object 30 vibrates greatly inside the housing 20, and the drive target object 30 hits the structure of the housing 20 at the end point of the range of movement, causing a collision sound such as ticking.

According to the drive system 10, the drive control unit 140 and the drive apparatus 40 can be set to the operating state to suppress the vibration of the drive target object 30 in response to the detection of the vibration of the drive target object 30, thus suppressing the generation of such an abnormal noise.

It is noted that in the drive system 10 shown above, in S330 to S340, the drive control unit 140 is configured to control the drive apparatus 40 so that the drive target object 30 is moved to the target position in response to the transition to the operating state by the detection of the vibration of the drive target object 30. Alternatively, the drive control unit 140 may also be configured to perform the control to generate any other driving force to suppress the vibration of the drive target object 30 by the drive apparatus 40. For example, the drive control unit 140 may also be configured to control the drive apparatus 40 so that the drive target object 30 is stopped at the current position detected by the position detection unit 130. Further for example, the drive control unit 140 may also be configured to apply driving force to the drive target object 30 toward a suitable position by performing controlling the flow of a certain current to the coils included in the drive apparatus 40, or other.

Also, in the drive system 10 shown above, the vibration detection unit 150 is configured to detect the vibration of the drive target object 30 using the measurement value from the sensor 50 for detecting the position of the drive target object 30. Alternatively, the vibration detection unit 150 may also be configured to detect the vibration of the drive target object 30 by detecting the vibration of an apparatus using the measurement value of a sensor that is not used for position detection of the drive target object 30 itself within the apparatus itself, such as a gyro sensor or an acceleration sensor that is included in another apparatus of the mobile terminal with the drive system 10 provided therein.

In the present embodiment, the drive target object 30 has a linear range of movement, that is, a range of movement represented by a one-dimensional position, within the housing 20. Alternatively, the drive target object 30 may also have a range of movement represented by a two-dimensional or three-dimensional position. In this case, the drive system 10 may have a drive apparatus 40, a sensor 50 and a drive control apparatus 100 for each dimension, and perform the vibration suppression process for each dimension.

FIG. 4 illustrates a first example of the vibration detection method of the drive system 10 according to the present embodiment. This figure illustrates the detection method and the suppressing method of the vibration of the drive target object 30 by the drive system 10 using the graph indicating the temporal change of the detected position of the drive target object 30 detected by the position detection unit 130.

In the example of this figure, the vibration detection unit 150 is configured to detect the vibration of the drive target object 30 based on the displacement amount of the detected position of the drive target object 30. More specifically, the vibration detection unit 150 is configured to detect the vibration of the drive target object 30 when the displacement amount of the detected position of the drive target object 30 is greater than the threshold value.

The position detection unit 130 is configured to detect the position of the drive target object 30 in a predetermined cycle (for example, every 1 ms). The vibration detection unit 150 is configured to perform the process for detecting the vibration based on the displacement amount of the detected position of the drive target object 30 in the stop state of the drive control unit 140 and the drive apparatus 40. In the example of this figure, the displacement amount of the detected position of the drive target object 30 between the time t1 and the time t2 is referred to as X (amount of movement X). At time t2, when the displacement amount X is greater than the threshold value that is the criteria for detecting vibration, the vibration detection unit 150 is configured to detect the vibration of the drive target object 30. Herein, the vibration detection unit 150 may use the magnitude of the difference between the positions at time t1 and time t2 (absolute value) as the displacement amount X.

It is noted that the vibration detection unit 150 may also use the difference between the positions at any two time points during the period of the stop state, that is, the maximum value of the difference between the positions during the period, as the displacement amount X. Also, the vibration detection unit 150 may also be configured to detect the vibration of the drive target object 30 when at least one of the velocity or acceleration based on the displacement amount of the detected position and the time required for the drive target object 30 being displaced in the displacement amount is greater than the threshold value. For example, the vibration detection unit 150 is configured to calculate the displacement amount of the detected position for each predetermined unit of time (for example, 5 ms) and so on as the speed of the drive target object 30, and to detect the vibration of the drive target object 30 when this speed is greater than a threshold value set as the upper limit of the speed. Also, for example, the vibration detection unit 150 may be configured to calculate the rate of change of the displacement amount of the detected position of the drive target object 30 as the acceleration of the drive target object 30, and to detect the vibration of the drive target object 30 when this acceleration is greater than a threshold value set as the upper limit of the acceleration. Also, the vibration detection unit 150 may be configured to detect the vibration according to the AND condition of the velocity and acceleration conditions, or may be configured to detect the vibration by the OR condition.

When the vibration detection unit 150 detects the vibration of the drive target object 30 at time t2, the state control unit 160 is configured to transition the drive control unit 140 and the drive apparatus 40 from the stop state to the operating state. Correspondingly, the drive control unit 140 is configured to start the drive of the drive target object 30 by the drive apparatus 40 in order to suppress the vibration of the drive target object 30. As shown in this figure, the state control unit 160 is configured to start the drive of the drive target object 30 at the time point when the initial movement of the vibration of the drive target object 30 has been detected, and to suppress the continuation of the vibration.

The drive control unit 140 is configured to perform the control to drive the drive target object 30 so that the drive target object 30 is moved to the predetermined fixed position inside the housing 20. In the example of this figure, this fixed position is an end point (an end point on the negative side) of the range of movement of the drive target object 30 inside the housing 20. For example, when the drive target object 30 is a lens, the drive target object 30 is movable from the end point on the negative side (limit position) to the end point on the positive side (limit position) inside the housing 20 that is a lens housing. For example, when the drive apparatus 40 is a drive apparatus for focusing that moves the lens perpendicular to the optical axis, the end point on the negative side corresponds to the focus position at infinity, for example, and the end point on the positive side corresponds to the focus position at the minimum shooting distance in macro photography, for example. In the example of this figure, the drive control unit 140 is configured to perform the control to move the drive target object 30 to the fixed position that is the end point on the negative side.

At time t3, the drive target object 30 is moved to an end point of the range of movement inside the housing 20. Since the drive system 10 is configured to maintain the drive target object 30 to be at the end point position of the range of movement until the end of the vibration suppression after time t3, thus the vibration of the drive target object 30 can be prevented even if a vibration is further applied to the apparatus with the drive target object 30.

Herein, the drive control unit 140 may control the drive of the drive apparatus 40 to further bias the drive target object 30 toward the end point side (negative side in this example) with the drive target object 30 moved to the end point of the range of movement within the housing 20. In this way, the drive system 10 can maintain the state in which the drive target object 30 is pressed against the end point of the range of movement inside the housing 20, that is, for example, the state in which the drive target object 30 is pressed against a structure located at the end point of the range of movement, until the vibration suppression ends. According to such control, the drive system 10 can suppress the drive target object 30 to move away from this end point to the positive side and to collide with the end point again, even if an even greater vibration is applied to an apparatus with the drive target object 30.

Instead of the above, the fixed position to which the drive target object 30 is moved may be the end point on the positive side in the range of movement of the drive target object 30, or it may be a position between the end points on the positive side and the negative side within the range of movement (for example, the midpoint position). When maintaining the drive target object 30 at the position between the end points within the range of movement until the vibration suppression ends, the drive control unit 140 is configured to generate the driving force by the drive apparatus 40 that does not cause the drive target object 30 to contact the structure at the end points of the range of movement. This enables the drive system 10 to prevent the drive target object 30 from colliding with the end point unless a very large vibration is applied.

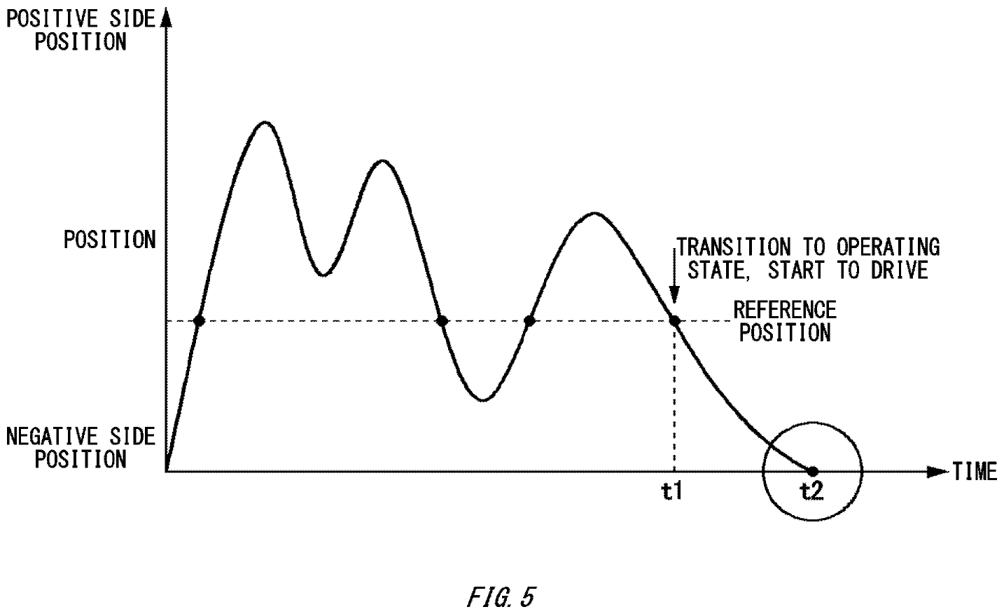

FIG. 5 illustrates a second example of the vibration detection method of the drive system 10 according to the present embodiment. Similar to FIG. 4, this figure illustrates the detection method and the suppressing method of the vibration of the drive target object 30 by the drive system 10 using the graph indicating the temporal change of the detected position of the drive target object 30 by the position detection unit 130.

In the example of this figure, the vibration detection unit 150 is configured to detect the vibration of the drive target object 30 based on the number of times of the drive target object 30 crossing a predetermined reference position. For example, the vibration detection unit 150 is configured to detect the vibration of the drive target object 30 in response to the number of times the drive target object 30 crossing the reference position exceeding a threshold value. In this way, the vibration detected by the vibration detection unit 150 is a narrowly defined “vibration” involving a reciprocating movement of the drive target object 30.

In the example of this figure, the drive control unit 140 and the drive apparatus 40 are in the stop state until time t1, and the drive target object 30 is vibrating within the range of movement crossing the “reference position” in the figure for four times. Herein, crossing the reference position means that the position of the drive target object 30 changes through the reference position, by changing from a smaller value to a larger value than the reference position, or changing from a larger value to a smaller value than the reference position.

At time t1, the vibration detection unit 150 is configured to detect the vibration of the drive target object 30 in response to the number of times the drive target object 30 crossing the reference position exceeding a threshold value of 3. Correspondingly, the state control unit 160 is configured to transition the drive control unit 140 and the drive apparatus 40 from the stop state to the operating state, and to move the drive target object 30 to the predetermined fixed position inside the housing 20 in the same manner as the case of FIG. 4.

The vibration detection unit 150 can identify the state in which the drive target object 30 is shaking between the positive side and the negative side of the reference position as “vibration” by detecting the vibration of the drive target object 30 using the number of times of crossing the reference position.

It is noted that the vibration detection unit 150 may also be configured to detect the vibration of the drive target object 30 based on the number of times of the drive target object 30 crossing the predetermined reference position within a period with a predetermined length. For example, the vibration detection unit 150 may also be configured to detect the vibration of the drive target object 30 based on the number of times of the drive target object 30 crossing the reference position, which is located between the end points in the range of movement of the drive target object 30 within a period with a predetermined length of five seconds.

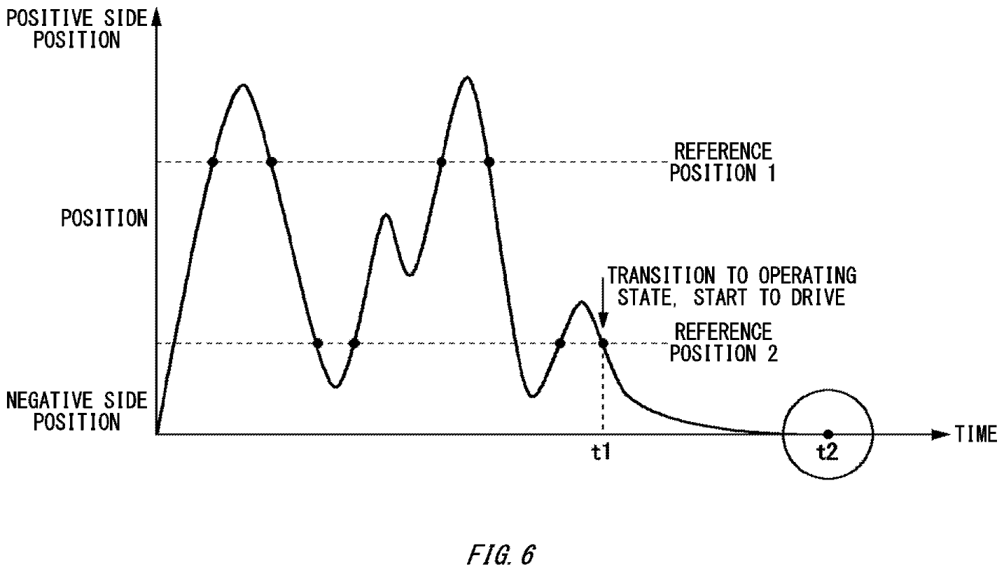

FIG. 6 illustrates a third example of the vibration detection method of the drive system 10 according to the present embodiment. Similar to FIG. 4, this figure illustrates the detection method and the suppressing method of the vibration of the drive target object 30 by the drive system 10 using the graph indicating the temporal change of the detected position of the drive target object 30 by the position detection unit 130.

In the example of this figure, the vibration detection unit 150 is configured to detect the vibration of the drive target object 30 based on the number of times of drive target object 30 crossing a plurality of predetermined reference positions. For example, the vibration detection unit 150 is configured to detect the vibration of the drive target object 30 in response to the number of times the drive target object 30 crosses any of the plurality of reference positions exceeding a threshold value.

In the example of this figure, the drive control unit 140 and the drive apparatus 40 are in the stop state until time t1, and the drive target object 30 is vibrating within the range of movement crossing the reference position 1 and 2 in the figure for eight times in total. At time t1, the vibration detection unit 150 is configured to detect the vibration of the drive target object 30 in response to the number of times the drive target object 30 crosses the reference position 1 and 2 exceeding a threshold value of 7. Correspondingly, the state control unit 160 is configured to transition the drive control unit 140 and the drive apparatus 40 from the stop state to the operating state, and to move the drive target object 30 to the predetermined fixed position inside the housing 20 in the same manner as the case of FIG. 4.

By detecting the vibration of the drive target object 30 using the number of times of crossing a plurality of mutually different reference positions, the vibration detection unit 150 can detect the vibration of the drive target object 30 at a position closer to the end point on the positive side or the negative side, which cannot be detected when a reference position is provided at a single location, such as the midpoint position between the end points of the range of movement of the drive target object 30, for example. Herein, although the case of two reference positions is exemplified in this figure, the number of the reference positions may be three (for example, near the end point on the positive side, midpoint, near the end point on the negative side), or may be four or more.

It is noted that in this example, in the same manner as the example of FIG. 5, the vibration detection unit 150 may also be configured to detect the vibration of the drive target object 30 based on the number of times of the drive target object 30 crossing the plurality of predetermined reference positions within a period with a predetermined length. Also, if a larger vibration is to be a detection target, the vibration detection unit 150 may detect a vibration of the drive target object 30 based on the number of times of the position of the drive target object 30 crossing the plurality of reference positions continuously, such as crossing the reference position 1 and the reference position 2 continuously, or more specifically, such as changing from the second crossing point to the third crossing point, changing from the fourth crossing point to the fifth crossing point, and changing from the sixth crossing point to the seventh crossing point.

Furthermore, the vibration detection unit 150 may also be configured to detect the vibration of the drive target object 30 in response to at least one of a plurality of detection conditions being satisfied. For example, the vibration detection unit 150 may be configured to detect the vibration of the drive target object 30 when at least one of the detection conditions shown in relation to FIG. 4 to FIG. 6 is satisfied.

A variety of embodiments of the present invention may be described with reference to flowcharts and block diagrams, where the blocks may represent: (1) steps of processes in which operations are performed; or (2) sections of devices responsible for performing the operations. Certain steps and sections may be implemented by dedicated circuitry, programmable circuitry supplied together with computer readable instructions stored on the computer readable medium, and/or a processor supplied together with computer readable instructions stored on the computer readable medium. Dedicated circuitry may include digital and/or analog hardware circuits and may include integrated circuits (IC) and/or discrete circuits. Programmable circuitry may include reconfigurable hardware circuits comprising, for example, logical AND, logical OR, logical XOR, logical NAND, logical NOR, and other logical operations, and memory elements such as flip-flops, registers, field-programmable gate arrays (FPGA), programmable logic arrays (PLA) or other.

Computer readable medium may include any tangible device that can store instructions for execution by a suitable device, such that the computer readable medium having instructions stored thereon comprises a product including instructions which can be executed to create means for performing operations specified in the flowcharts or block diagrams. Examples of computer readable medium may include an electronic storage medium, a magnetic storage medium, an optical storage medium, an electromagnetic storage medium, a semiconductor storage medium, or other. More specific examples of the computer-readable medium may include: a floppy (registered trademark) disk; a diskette; a hard disk; a random access memory (RAM); a read-only memory (ROM); an erasable programmable read-only memory (EPROM or flash memory); an electrically erasable programmable read-only memory (EEPROM); a static random access memory (SRAM); a compact disk read-only memory (CD-ROM); a digital versatile disk (DVD); a BLU-RAY (registered trademark) disk; a memory stick; and an integrated circuit card, or other.

Computer readable instructions may include assembler instructions, instruction-set-architecture (ISA) instructions, machine instructions, machine dependent instructions, microcode, firmware instructions, state-setting data, or either described source code or object code written in any combination of one or more programming languages, including an object oriented programming language such as Smalltalk (registered trademark), JAVA (registered trademark), C++, etc., and conventional procedural programming languages, such as the “C” programming language or similar programming languages.

Computer-readable instructions may be provided to a processor of a general purpose computer, a special purpose computer, or other programmable data processing apparatus of another computer, or to a programmable circuitry, locally or via a local area network (LAN), wide area network (WAN) such as the Internet, etc., and the computer-readable instructions may be executed to create means for performing operations specified in the flowcharts or block diagrams. Examples of processors include computer processors, processing units, microprocessors, digital signal processors, controllers, microcontrollers, or other.

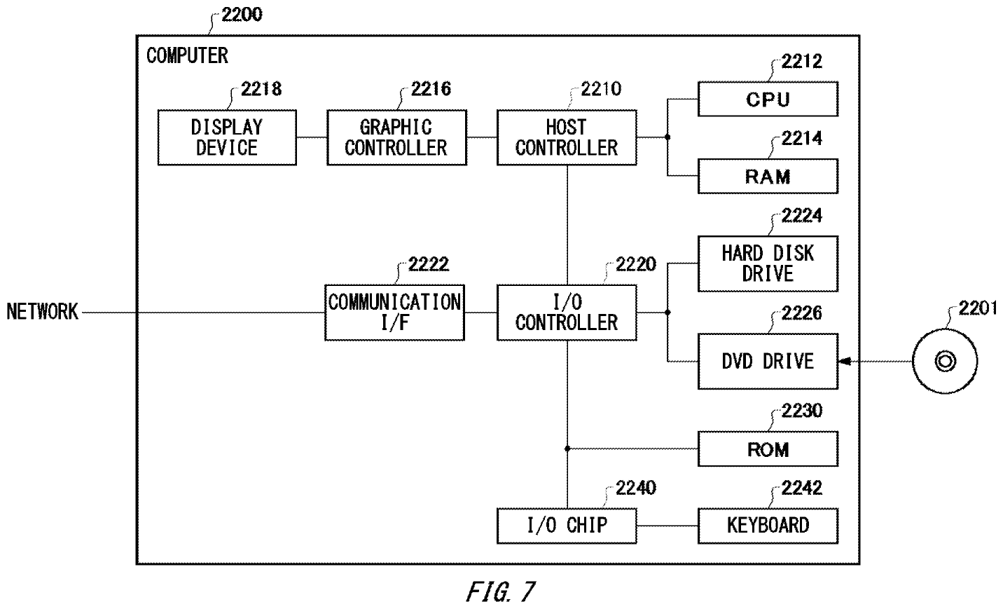

FIG. 7 illustrates an example of a computer 2200 in which a plurality of aspects of the present invention may be embodied in whole or in part. A program that is installed in the computer 2200 can cause the computer 2200 to function as or perform operations associated with the device according to the embodiments of the present invention or one or more sections of said device, or perform said operations or said one or more sections, and/or cause the computer 2200 to perform the processes according to the embodiments of the present invention or steps of said processes. Such a program may be executed by the CPU 2212 to cause the computer 2200 to perform certain operations associated with some or all of the blocks of flowcharts and block diagrams described herein.

The computer 2200 according to the present embodiment includes a CPU 2212, an RAM 2214, a graphic controller 2216, and a display device 2218, which are mutually connected by a host controller 2210. The computer 2200 also includes input/output units such as a communication interface 2222, a hard disk drive 2224, a DVD-ROM drive 2226 and an IC card drive, which are connected to the host controller 2210 via an input/output controller 2220. The computer also includes legacy input/output units such as an ROM 2230 and a keyboard 2242, which are connected to the input/output controller 2220 via an input/output chip 2240.

The CPU 2212 operates according to programs stored in the ROM 2230 and the RAM 2214, thereby controlling each unit. The graphic controller 2216 obtains image data generated by the CPU 2212 on a frame buffer or other provided in the RAM 2214 or in itself, and causes the image data to be displayed on the display device 2218.

The communication interface 2222 communicates with other electronic devices via the network. The hard disk drive 2224 stores programs and data used by the CPU 2212 in the computer 2200. The DVD-ROM drive 2226 reads the programs or the data from the DVD-ROM 2201, and provides the hard disk drive 2224 with the programs or the data via the RAM 2214. The IC card drive reads programs and data from an IC card, and/or writes programs and data into the IC card.

The ROM 2230 stores therein a boot program or other to be executed by the computer 2200 when activated, and/or a program which depends on the hardware of the computer 2200. The input/output chip 2240 may also connect a variety of input/output units to the input/output controller 2220, via a parallel port, a serial port, a keyboard port, a mouse port, or other.

A program is provided by computer readable medium such as the DVD-ROM 2201 or an IC card. The program is read from the computer readable medium, installed into the hard disk drive 2224, RAM 2214, or ROM 2230, which are also examples of computer readable media, and executed by the CPU 2212. The information processing described in these programs is read into the computer 2200, which results in cooperation between a program and a variety of types of hardware resources mentioned above. The device or the method may be configured by realizing the operation or processing of information in accordance with the use of the computer 2200.

For example, when communication is executed between the computer 2200 and an external device, the CPU 2212 may execute a communication program loaded onto the RAM 2214 and instruct the communication interface 2222 to perform communication processing based on the processing described in the communication program. Under the control of the CPU 2212, the communication interface 2222 reads transmission data stored in a transmit buffer processing area provided in a recording medium such as the RAM 2214, the hard disk drive 2224, the DVD-ROM 2201, or the IC card, and then transmits the read transmission data to the network or writes reception data received from the network in a receive buffer processing area etc. provided in the recording medium.

In addition, the CPU 2212 may cause all or a necessary portion of a file or a database to be read into the RAM 2214, the file or the database having been stored in an external recording medium such as the hard disk drive 2224, the DVD-ROM drive 2226 (DVD-ROM 2201), the IC card or other, and perform a variety of types of processing on the data on the RAM 2214. The CPU 2212 may then write back the processed data to the external recording medium.

A variety of types of information, such as a variety of types of programs, data, tables, and databases, may be stored in the recording medium to undergo information processing. The CPU 2212 may perform a variety of types of processing on the data read from the RAM 2214, which includes a variety of types of operations, information processing, condition determination, conditional branch, unconditional branch, retrieval/replacement of information or other, as described anywhere throughout this disclosure and designated by an instruction sequence of programs, and writes the result back to the RAM 2214. In addition, the CPU 2212 may retrieve information in a file, a database or other, in a recording medium. For example, if a plurality of entries are stored in the recording medium, where each entry has an attribute value of a first attribute associated with an attribute value of a second attribute, the CPU 2212 may retrieve an entry which matches the condition having a designated attribute value of the first attribute, from among said plurality of entries, and read the attribute value of the second attribute stored in said entry, thereby obtaining the attribute value of the second attribute associated with the first attribute which meets the predetermined condition.

The program or software modules described above may be stored in the computer readable medium on the computer 2200 or in the vicinity of the computer 2200. In addition, a recording medium such as a hard disk or an RAM provided in a server system connected to a dedicated communication network or the Internet can be used as the computer readable medium, thereby providing the program to the computer 2200 via the network.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. A drive control apparatus, comprising:
a drive control unit for generating driving force for driving a drive target object by a drive apparatus in a first operating state, and performing control to reduce or stop the driving force of the drive apparatus in a second operating state;
a detection unit for detecting a position change of the drive target object; and
a state control unit for transitioning the drive control unit to the first operating state to make the drive control unit perform control to generate the driving force by the drive apparatus to suppress a continued position change in response to a position change exceeding predetermined criteria being detected in the second operating state.

2. The drive control apparatus according to claim 1, wherein:
the drive apparatus is configured to
apply magnetic force to a magnet provided in the drive target object by driving a coil to drive the drive target object in the first operating state; and
reduce the magnetic force or stop generating the magnetic force to allow the drive target object to be moved when external force is applied thereto in the second operating state.

3. The drive control apparatus according to claim 1, wherein:
the state control unit is configured to transition the drive control unit to the second operating state in response to elapse of a predetermined period after switching the drive control unit to the first operating state by detecting a position change exceeding the predetermined criteria.

4. The drive control apparatus according to claim 2, wherein:
the state control unit is configured to transition the drive control unit to the second operating state in response to elapse of a predetermined period after switching the drive control unit to the first operating state by detecting a position change exceeding the predetermined criteria.

5. The drive control apparatus according to claim 1, wherein:
the detection unit includes a vibration detection unit for detecting a vibration of the drive target object; and
the state control unit is configured to transition the drive control unit from the second operating state to the first operating state in response to the vibration being detected by the vibration detection unit.

6. The drive control apparatus according to claim 2, wherein:
the detection unit includes a vibration detection unit for detecting a vibration of the drive target object; and
the state control unit is configured to transition the drive control unit from the second operating state to the first operating state in response to the vibration being detected by the vibration detection unit.

7. The drive control apparatus according to claim 5, wherein:
the drive control unit is configured to perform control for generating the driving force to suppress the vibration by the drive apparatus in response to a transition to the first operating state by detecting a position change exceeding the predetermined criteria.

8. The drive control apparatus according to claim 1, wherein:
the drive target object is housed in a housing; and
the drive control unit is configured to perform control to move the drive target object to a predetermined fixed position within the housing in response to a transition to the first operating state by detecting a position change exceeding the predetermined criteria.

9. The drive control apparatus according to claim 8, further comprising a target position setting unit for setting a target position of the drive target object, wherein:
the target position setting unit is configured to output position information indicating the fixed position in response to the drive control unit transitioning to the first operating state by detecting a position change exceeding the predetermined criteria; and
the drive control unit is configured to perform control to move the drive target object to the fixed position based on the position information.

10. The drive control apparatus according to claim 8, wherein the fixed position is an end point of a range of movement of the drive target object.

11. The drive control apparatus according to claim 1, wherein:
the drive control unit is configured to perform control to generate, by the drive apparatus, the driving force that does not cause the drive target object to contact a structure at an end point of a range of movement of the drive target object in response to a transition to the first operating state by detecting a position change exceeding the predetermined criteria.

12. The drive control apparatus according to claim 1, wherein:
the detection unit is configured to detect a position change exceeding the predetermined criteria of the drive target object based on a displacement amount of a detected position of the drive target object.

13. The drive control apparatus according to claim 12, wherein:
the detection unit is configured to detect a position change exceeding the predetermined criteria of the drive target object when a displacement amount of the detected position is greater than a threshold value.

14. The drive control apparatus according to claim 12, wherein:
the detection unit is configured to detect a position change exceeding the predetermined criteria of the drive target object when at least one of speed and acceleration based on a displacement amount of the detected position and a period of time for the drive target object being displaced by the displacement amount is greater than a threshold value.

15. The drive control apparatus according to claim 1, wherein:
the detection unit is configured to detect a position change exceeding the predetermined criteria based on a number of times the drive target object crosses a predetermined reference position.

16. The drive control apparatus according to claim 15, wherein:
the detection unit is configured to detect a position change exceeding the predetermined criteria based on a number of times of the drive target object crossing a plurality of the predetermined reference position.

17. The drive control apparatus according to claim 1, wherein:
the drive target object is a lens of an image capturing apparatus;
the drive control unit is configured to perform control of at least one of focusing, zooming or blur suppressing the lens by driving the lens when performing image capturing by the image capturing apparatus.

18. A drive system, comprising:
the drive control apparatus according to claim 1; and
a drive apparatus for driving the drive target object according to the control by the drive control apparatus.

19. A drive control method, comprising:
causing a drive control apparatus to generate driving force for driving a drive target object by a drive apparatus in a first operating state, and to reduce or stop the driving force of the drive apparatus in a second operating state;
detecting, by the drive control apparatus, a position change of the drive target object; and
transitioning, by the drive control apparatus, to the first operating state in response to a position change exceeding predetermined criteria being detected in the second operating state and to perform control to generate the driving force by the drive apparatus.

20. A computer-readable medium having recorded thereon a drive control program that, when executed by a computer, causes the computer to function as:
a drive control unit for generating driving force for driving a drive target object by a drive apparatus in a first operating state, and performing control to reduce or stop the driving force of the drive apparatus in a second operating state;
a detection unit for detecting a position change of the drive target object; and
a state control unit for transitioning the drive control unit to the first operating state to make the drive control unit perform control to generate the driving force by the drive apparatus to suppress a continued position change in response to a position change exceeding predetermined criteria being detected in the second operating state.
